(19) United States
(12) Patent Application Publication
(10) Pub. No.: US 2026/0004173 A1
(43) Pub. Date: Jan. 1, 2026

(54) STATIC PARTITION SWITCHING FOR LARGE-SCALE QUANTUM SYSTEMS

(71) Applicant: International Business Machines Corporation, Armonk, NY (US)

(72) Inventors: Zachary Kauffman, Rochester, MN (US); Timothy Lindquist, Rochester, MN (US); Paul Schardt, Rochester, MN (US); Frank Haverkamp, Tuebingen (DE); Matthew A. Walther, Rochester, MN (US); Isaac Lauer, Chappaqua, NY (US); Tristan Müller, Tübingen (DE); Andre Avila Alves, Hamburg (DE)

(21) Appl. No.: 18/524,558

(22) Filed: Nov. 30, 2023

(51) Int. Cl. G06N 10/40

(52) U.S. Cl. CPC G06N 10/40

(57) ABSTRACT

A system comprises a memory that stores and a processor that executes computer executable components stored in the memory, wherein the computer executable components comprise an identification component that identifies a target partition definition for a quantum processor comprising a plurality of qubits, and a mapping component that directs a controller of a quantum system, comprising the quantum processor, to apply the target partition definition to control electronics at the quantum system for subsequent of an operation at the quantum processor, wherein the target partition definition corresponds to a quantum system resource, of the quantum system, associated with a target qubit of the plurality of qubits.

### BACKGROUND

In quantum computing systems, quantum processors can comprise a plurality of qubits, such as in the hundreds or in the future, in the thousands, millions or billions. Each qubit can be associated with one or more controllers, such as a qubit control card, qubit acquire card and/or qubit drive card. Preparation of a quantum system for execution of a quantum circuit can comprise preparation of a set of such controllers for a set of such qubits.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide for control of a quantum system through use of partitioning of resources of the quantum system.

In accordance with an embodiment, a system can comprise a memory that stores and a processor that executes computer executable components stored in the memory, wherein the computer executable components comprise an identification component that identifies a target partition definition for a quantum processor comprising a plurality of qubits, and a mapping component that directs a controller of a quantum system, comprising the quantum processor, to apply the target partition definition to control electronics of the quantum system for execution of an operation at the quantum processor, wherein the target partition definition corresponds to a quantum system resource, of the quantum system, associated with a target qubit of the plurality of qubits.

In accordance with another embodiment, a computer-implemented method can comprise identifying, by a system operatively coupled to a processor, a target partition definition for a quantum processor comprising a plurality of qubits, and directing, by the system, a controller of a quantum system, comprising the quantum processor, to apply the target partition definition to control electronics of the quantum system for execution of an operation at the quantum processor, wherein the target partition definition corresponds to a quantum system resource, of the quantum system, associated with a target qubit of the plurality of qubits.

In accordance with still another embodiment, a computer program product facilitating a process to manage a set of partitions corresponding to a set of qubits of a quantum processor of a quantum system, the computer program product comprising a computer readable storage medium having program instructions embodied therewith, the program instructions executable by a processor to cause the processor to identify, by the processor, a target partition definition for the quantum processor comprising the set of qubits, and direct, by the processor, a controller of the quantum system, comprising the quantum processor, to apply the target partition definition to control electronics of the quantum system for execution of an operation at the quantum processor, wherein the target partition definition corresponds to a quantum system resource, of the quantum system, associated with a target qubit of the set of qubits.

A benefit of the system, computer-implemented method and/or computer program product can be that the mapping and unmapping operations performed are not tied to any particular job. Rather, dynamic reconfiguration of partitioning of a set of quantum system resources of a quantum system can be repeatedly performed for part or all of the set of quantum system resources. In this way, the partitioning can be reconfigurable to construct different sized logical systems from the quantum system for use with varying quantum job requests.

Yet another benefit of the system, computer-implemented method and/or computer program product can be a significant reduction in bring up time (e.g., comprising initialization and/or calibration) of a quantum system comprising a plurality of qubits. For example, relative to a quantum system comprising a few hundred qubits, such as four-hundred or more qubits, a bring up time can be reduced from months to less than two weeks due to parallelization of bring up operations in view of the partitioning applied to the quantum system (e.g., to the control electronics).

In connection with this benefit, the one or more embodiments described herein can allow for less overall downtime of qubits of the quantum system. That is, by partitioning off logical subsystems of a quantum system, some qubits can be calibrated (e.g., of one partition) while other qubits can be employed to execute a quantum job (e.g., of another partition). Further, this partitioning can be reconfigured and changed for new calibrations and/or quantum job requests.

Still another benefit of the system, computer-implemented method and/or computer program product can be use of partitioning to exclude one or more quantum system resources (e.g., provide partition of quantum system resources to not be used for any particular quantum job) to allow for segregation of broken hardware (e.g., hardware failure), hardware subject to a troubleshooting operation, and/or hardware that is failing to calibrate properly, among other suitable purposes. This can be a desirable alternative to taking an entire quantum system offline.

### DESCRIPTION OF THE DRAWINGS

FIG. 1 illustrates a block diagram of an example, non-limiting system that can provide a process to map and/or unmap quantum system resources using resource partitioning, in accordance with one or more embodiments described herein.

FIG. 2 illustrates a block diagram of another example, non-limiting system that can provide a process to map and/or unmap quantum system resources using resource partitioning, in accordance with one or more embodiments described herein.

FIG. 3 provides an illustration of quantum system descriptions that can be executed by the non-limiting system of FIG. 2, in accordance with one or more embodiments described herein.

FIG. 4 provides an illustration of quantum system descriptions that can be executed by the non-limiting system of FIG. 2, in accordance with one or more embodiments described herein.

FIG. 5 illustrates a block diagram of a quantum system that can be employed in connection with the non-limiting systems of FIGS. 1 and 2, in accordance with one or more embodiments described herein.

FIG. 6A illustrates a flow diagram of elements that can be employed for different partitions by the non-limiting system of FIG. 2, in accordance with one or more embodiments described herein.

FIG. 6B illustrates a flow diagram of processes that can be performed by the non-limiting system of FIG. 2 for different partitions in association with a partitioning setup operation, in accordance with one or more embodiments described herein.

FIG. 6C illustrates a flow diagram of processes that can be performed by the non-limiting system of FIG. 2 for different partitions in association with a partitioning setup operation, in accordance with one or more embodiments described herein.

FIG. 6D illustrates a flow diagram of processes that can be performed by the non-limiting system of FIG. 2 for different partitions in association with a qubit driving operation, in accordance with one or more embodiments described herein.

FIG. 6E illustrates a flow diagram of processes that can be performed by the non-limiting system of FIG. 2 for different partitions in association with a qubit driving operation, in accordance with one or more embodiments described herein.

FIG. 6F illustrates a flow diagram of processes that can be performed by the non-limiting system of FIG. 2 for different partitions in association with a qubit readout/acquiring operation, in accordance with one or more embodiments described herein.

FIG. 6G illustrates a flow diagram of processes that can be performed by the non-limiting system of FIG. 2 for different partitions in association with a qubit readout/acquiring operation, in accordance with one or more embodiments described herein.

FIG. 7 illustrates schematics of an exemplary clean system and partitioned system, based on the non-limiting system of FIG. 2, in accordance with one or more embodiments described herein.

FIG. 8 illustrates schematics of an unclean system, another exemplary clean system and another partitioned system, based on the non-limiting system of FIG. 2, in accordance with one or more embodiments described herein.

FIG. 9 illustrates a flow diagram of one or more processes that can be performed by the non-limiting system of FIG. 2, to map and/or unmap quantum system resources using resource partitioning, in accordance with one or more embodiments described herein.

FIG. 10 illustrates a continuation of the flow diagram of FIG. 9 of one or more processes that can be performed by the non-limiting system of FIG. 2, in accordance with one or more embodiments described herein.

FIG. 11 illustrates a block diagram of an example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In practice, quantum processors can comprise a plurality of qubits, such as in the hundreds, or in the future, in the thousands, millions or even billions. A qubit can be associated with one or more subordinate controllers, such as a qubit control card, qubit acquire card (e.g., readout electronics) and/or qubit drive card (e.g., waveform generator) that is controlled by a global or master controller. Initialization and calibration of a quantum system for execution of a quantum circuit can comprise initialization and calibration of a set of such controllers for a set of such qubits.

However, initialization and calibration of tens, hundreds, thousands, millions or even billions of qubits and/or of their associated qubit cards can be a time intensive, labor intensive and/or power intensive process, without being limited thereto.

Accordingly, to account for one or more of these deficiencies of existing preparation frameworks for quantum systems (e.g., for initialization and/or calibration), one or more embodiments described herein can provide for partitioning of quantum system resources of a quantum system through a series of mapping and/or unmapping operations. These operations can allow for a rapid increase in preparation time for a quantum system, for operation of a quantum system relative to a plurality of jobs in sequence or even at least partially in parallel with one another based on a single bring up operation (based on the mapping and/or unmapping operations), and/or for more efficient communication between a hierarchy of controllers of a quantum system, as compared to existing frameworks.

As such, the one or more embodiments described herein can provide for automatically mapping and/or unmapping quantum system resources, such qubit cards (e.g., qubit acquire cards, qubit drive cards, qubit control cards) based on partition definitions identified and/or generated by the one or more embodiments, where the partition definitions can be based on quantum system resource information stored at a directory communicatively coupled to the one or more embodiments.

Put another way, one or more embodiments described herein can provide a partitioning procedure to devote parts of a set of quantum controllers (e.g., of control electronics) to a partition while also configuring some network components such that an isolated communication is provided between those partition-dedicated controllers. The effect of this partitioning procedure is a portioning of a quantum processing unit, without actually partitioning the quantum processing unit. An unmapping procedure is generally an inverse thereof, where controllers are freed back into a free pool of quantum system resources, and with network configurations freed back to a free pool of network configurations. This is different from existing frameworks that instead partition resources, such as data, within a chip.

As used herein, the term “information” can comprise data and/or metadata in any suitable form, code and/or language.

As used herein, the term “data” can comprise metadata.

As used herein, the terms “entity,” “requesting entity,” and “user entity” can refer to a machine, device, component, hardware, software, smart device, party, organization, individual and/or human.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

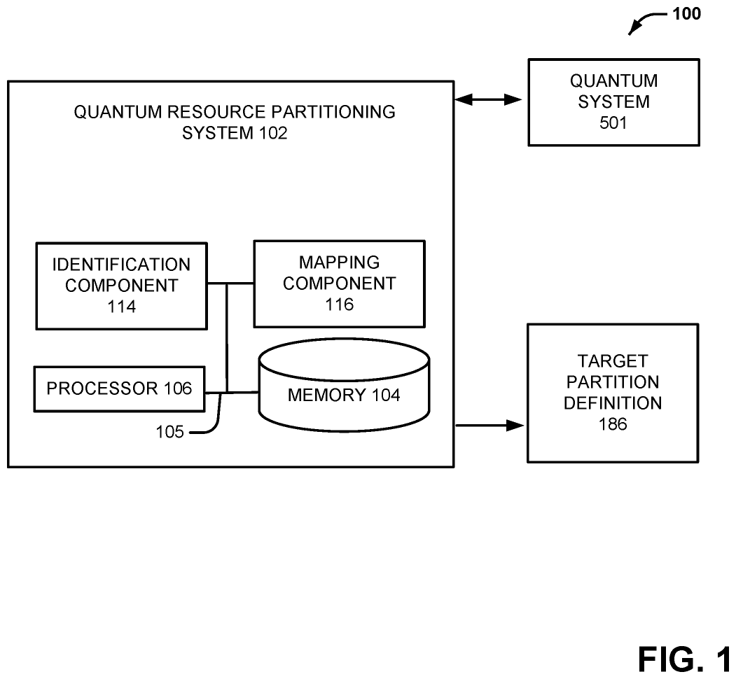

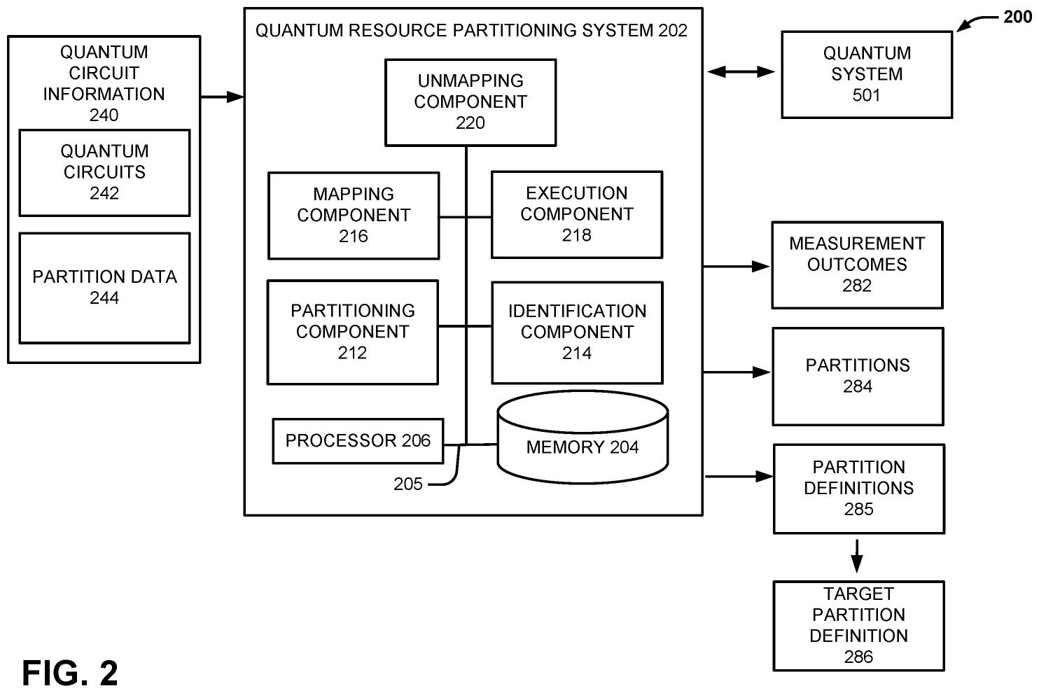

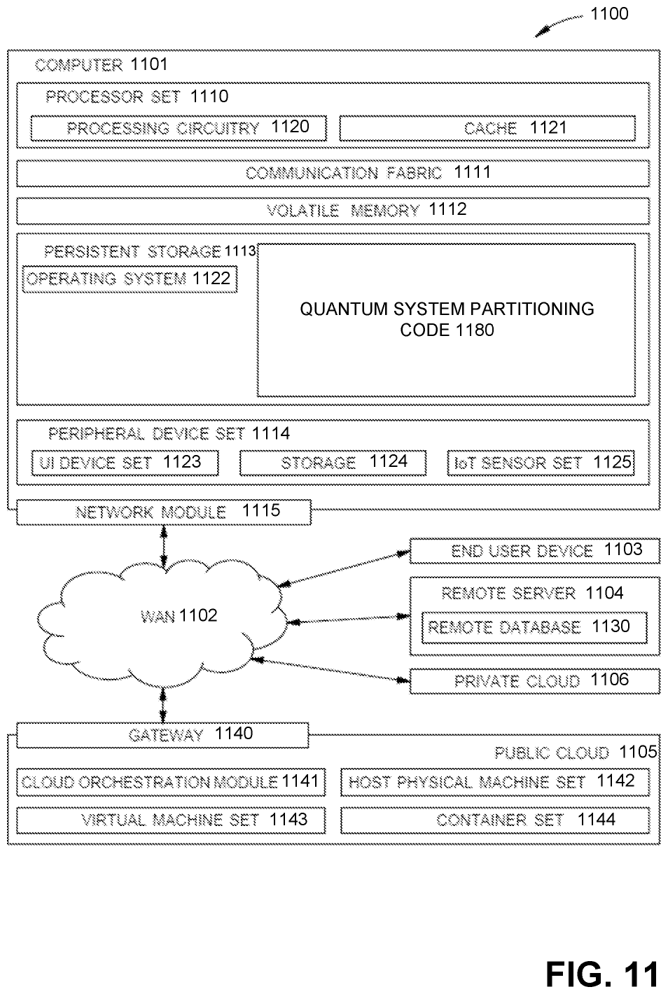

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1100 illustrated at FIG. 11. In one or more described embodiments, computer and/or computing-based elements can be used in connection with implementing one or more of the systems, devices, components and/or computer-implemented operations shown and/or described in connection with FIGS. 1 and/or 2 and/or with one or more other figures described herein.

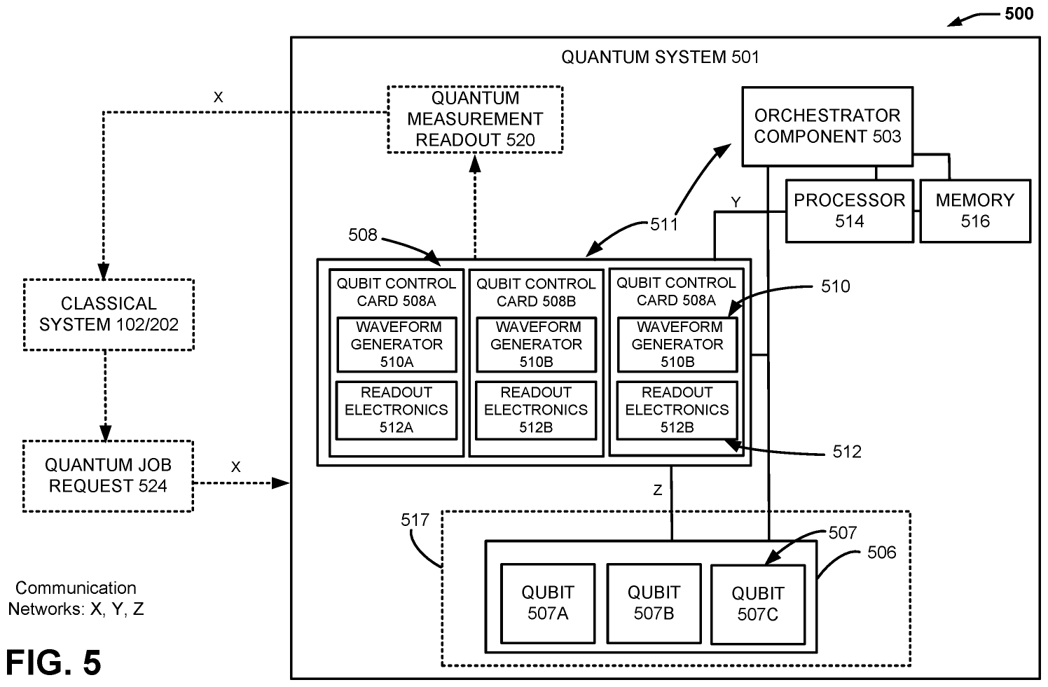

Turning now in particular to one or more figures, and first to FIG. 1, the figure illustrates a block diagram of an example, non-limiting system 100 that can facilitate a partitioning process relative to a plurality of quantum system resources of a quantum system 501 (FIG. 5).

The non-limiting system 100 can comprise a quantum resource partitioning system 102 and a quantum system 501, to be described in detail below. It is noted that the quantum resource partitioning system 102 is only briefly described relative to FIG. 1 to provide but a lead-in to description of a more complex and/or more expansive quantum resource partitioning system 202 as illustrated at FIG. 2. That is, further detail regarding processes that can be performed by one or more embodiments described herein will be provided below relative to the non-limiting system 200 of FIG. 2.

Still referring to FIG. 1, the quantum resource partitioning system 102 can comprise at least a memory 104, bus 105, processor 106, identification component 114 and mapping component 116. Using these components and the quantum system 501, the quantum resource partitioning system 102 can provide mapping and unmapping of quantum system resources, such as quantum control electronics 511, such as one or more orchestrator components 503 and/or qubit control cards 508 at the quantum system 501, allowing for execution of one or more quantum circuits at the quantum system 501.

Generally, the identification component 114 can identify a target partition definition 186 for a quantum processor (e.g., quantum processor 506 of the quantum system 501) comprising a plurality of qubits (e.g., qubits 507).

The mapping component 116 can generally direct a controller (e.g., orchestrator component 503), of a quantum system (e.g., quantum system 501) comprising the quantum processor (e.g., quantum processor 506), to apply the target partition definition 186 to control electronics of the quantum system (e.g., qubit control electronics 511 and one or more master controllers, such as orchestrator components 503) of the quantum system to thereby enable partitioned control of execution of an operation at the quantum processor.

The target partition definition 186 can correspond to a quantum system resource, of the quantum system, associated with a target qubit of the plurality of qubits. For example, the quantum system resource can be and/or can comprise quantum control electronics 511, such as one or more orchestrator components 503 and/or quantum control cards 508.

It is noted that the identification component 114 and the mapping component 116 each can operate at a classical system of and/or comprising the quantum resource partitioning system 102.

In general, the non-limiting system 100 can employ any suitable method of communication (e.g., electronic, communicative, internet, infrared, fiber, etc.) to provide communication between the quantum resource partitioning system 102 and the quantum system 501.

Turning next to FIG. 2, a non-limiting system 200 is illustrated that can comprise a quantum resource partitioning system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the quantum resource partitioning system 202 can provide reconfigurable mapping and/or unmapping of quantum system resources, which can comprise quantum control electronics 511, such as one or more orchestrator components 503 and/or quantum control cards 508, allowing for execution of one or more quantum circuits 242 at the quantum system 501.

Turning first to the quantum resource partitioning system 202, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The quantum resource partitioning system 202 can be associated with, such as accessible via, a cloud computing environment.

The quantum resource partitioning system 202 can comprise a plurality of components. The components can comprise a memory 204, processor 206, bus 205, partitioning component 212, identification component 214, mapping component 216, execution component 218 and/or unmapping component 220. Using these components, the quantum resource partitioning system 202 can generally identify and/or generate one or more partition definitions 285 and can direct use of the partition definitions 285 by one or more controllers at one or more hierarchal control levels of a quantum system 501. In this way, use of the partition definitions 285 by the quantum system 501 can allow for initialization, calibration and/or operation of quantum system resources, of the quantum system, which quantum system resources can be partitioned based on the partition definitions 285.

Discussion first turns briefly to the processor 206, memory 204 and bus 205 of the quantum resource partitioning system 202. For example, in one or more embodiments, the quantum resource partitioning system 202 can comprise the processor 206 (e.g., computer processing unit, microprocessor, classical processor, quantum processor and/or like processor). In one or more embodiments, a component associated with quantum resource partitioning system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the partitioning component 212, identification component 214, mapping component 216, execution component 218 and/or unmapping component 220.

In one or more embodiments, the quantum resource partitioning system 202 can comprise the computer-readable memory 204 that can be operably connected to the processor 206. The memory 204 can store computer-executable instructions that, upon execution by the processor 206, can cause the processor 206 and/or one or more other components of the quantum resource partitioning system 202 (e.g., partitioning component 212, identification component 214, mapping component 216, execution component 218 and/or unmapping component 220) to perform one or more actions. In one or more embodiments, the memory 204 can store computer-executable components (e.g., partitioning component 212, identification component 214, mapping component 216, execution component 218 and/or unmapping component 220).

The quantum resource partitioning system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the quantum resource partitioning system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the quantum resource partitioning system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the quantum resource partitioning system 202 and the quantum system 501.

In addition to the processor 206 and/or memory 204 described above, the quantum resource partitioning system 202 can comprise one or more computer and/or machine readable, writable and/or executable components and/or instructions that, when executed by processor 206, can provide performance of one or more operations defined by such component and/or instruction.

Discussion next turns to the additional components of the quantum resource partitioning system 202 (e.g., partitioning component 212, identification component 214, mapping component 216, execution component 218 and/or unmapping component 220).

Turning first to the partitioning component 212, the partitioning component 212 can generally generate one or more partitions 284 based on one or more partition definitions 285. The partitions 284, while not comprising a physical partitioning of quantum system resources of the quantum system 501, can provide for identified separation of different subsets of quantum system resources of the quantum system 501. The different subsets can separately receive different common communications (e.g., communications common to the quantum system resources of a subset), be initialized and/or calibrated separately, can have troubleshooting operations separately performed, and/or be utilized separately for separate quantum job requests (e.g., including quantum job requests being executed subsequently and/or at least partially in parallel at the same quantum system 501).

As mentioned above, the quantum system resources can comprise any one or more orchestrator components 503 and/or qubit control cards 508, without being limited thereto.

An orchestrator component 503 can serve as a master controller for one or more subordinate controllers being the qubit control cards 508. The subordinate controllers can be at least partially controlled by the master controller to control the quantum processing unit (QPU) 506.

Qubit controls cards 508 can be and/or can comprise qubit drive cards and/or qubit acquire cards. A qubit control card 508 can execute driving and acquiring operations for a qubit.

In one or more embodiments a qubit control card 508 can be provided per qubit 507. In one or more embodiments, a qubit control card 508 can be provided to communicate with more than one qubit 507 per that qubit control card 508. In one or more embodiments, a qubit control card 508 can be and/or can comprise only one of a qubit drive card or a qubit acquire card. In one or more embodiments, a qubit control card 508 can comprise more than one qubit drive card and/or more than one qubit acquire card.

A qubit drive card, such as a waveform generator 510, can execute driving operations for a qubit 507. Driving operations can comprise sending one or more signals, waveforms, pulses and/or other communications to the qubit 507, such as to drive the qubit 507 to a state different than a current state of the qubit 507.

In one or more embodiments a qubit drive card can be provided per qubit 507. In one or more embodiments, a qubit drive card can be provided to communicate with more than one qubit 507 per that qubit drive card. In one or more embodiments, a same qubit drive card can be employed for two or more qubits 507.

A qubit acquire card, such as readout electronics 512, can execute acquiring operations for a qubit 507. Acquiring operations can comprise measuring feedback from a qubit 507 and/or receiving feedback from a qubit 507, which feedback can be employed by the quantum system 501 to determine a state, rotation, frequency or other information of the qubit 507, and ultimately to output one or more quantum measurement readouts 520 (FIG. 5).

In one or more embodiments a qubit acquire card can be provided per qubit 507. In one or more embodiments, a qubit acquire card can be provided to communicate with more than one qubit 507 per that qubit acquire card. In one or more embodiments, a same qubit acquire card can be employed for two or more qubits 507.

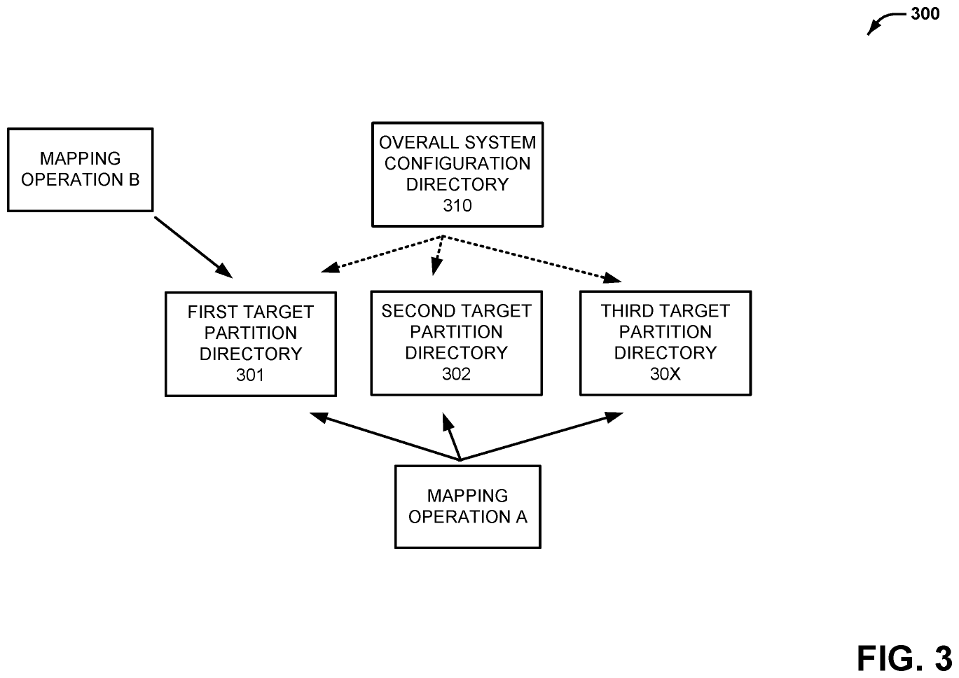

Turning briefly to schematic 300 of FIG. 3, in one or more embodiments, the partitioning component 212 can communicate with and/or read information of a system configuration directory 310 for the quantum system 501. The system configuration directory 310 can be stored at the memory 204 or at any other location internal to or external to the quantum resource partitioning system 202 and/or non-limiting system 200 that is communicatively accessible by the quantum resource partitioning system 202. The system configuration directory 310 can comprise data/metadata in any suitable format, code and/or language.

In one or more embodiments, the system configuration directory 310 can be a master system configuration directory comprising a master definition for one or more quantum system resources, such as all quantum system resources, of the quantum system 501.

In one or more embodiments, the system configuration directory 310 can comprise information defining specifications, configurations, names, IDs, calibration settings, initialization settings and/or execution settings, without being limited thereto, for one or more, such as all, quantum system resources of the quantum system 501. This information can thus define operation, location, setup, physical connection, communicative connection, operation frequency and/or power requirement of a quantum system resource, without being limited thereto.

Using the information of the system configuration directory 310, one or more partitions 284 can be generated, with a partition 284 being associated with a respective partition directory 301, 302 . . . 30X and comprising information comprising and/or specifying an associated partition definition 285. A partition directory 30X can be populated based on use of an ID, flag and/or other pointer referencing the information of one or more quantum system resources of the overall system configuration directory 310.

In one or more embodiments, based on quantum circuit information 240, information for a determined set of qubits 507 to be employed for execution of a quantum job, e.g., a quantum circuit 242, can be populated to a partition directory 30X, thus defining a partition 284. That is, the information for the determined set of qubits 507 can comprise and/or be employed to generate the partition definitions 285 by the partitioning component 212.

It is noted that, for each quantum system resource corresponding to a partition directory, that partition directory can comprise reference to, link to and/or a copy of all or a portion of the information corresponding to that quantum system resource.

All or a portion of the quantum system resources of the quantum system 501 can be repeatedly and reconfigurably partitioned in this manner, through the generation of a plurality of partition directories 301, 302 . . . 30X defining a plurality of partitions 284 defined by a plurality of corresponding partition definitions 285.

It is noted that the partitions generally will not overlap, in that a quantum system resource of one partition 284 will not be also partitioned to another partition 284.

In one or more embodiments, determination of which quantum system resources to partition together, which quantum system resources to employ for any particular quantum job and/or the like can be performed manually by a user entity.

Additionally, and/or alternatively, in one or more embodiments, partition data 244, as output by a device associated with such user entity, can be employed by the partitioning component 212 as building blocks upon which the partition directories 30X can be generated.

It is noted that upon completion of the generation of any set of the partition directories 30X, the partition directories 30X can be stored at any suitable location of the non-limiting system 200, quantum resource partitioning system 202, quantum system 501 and/or other suitable location.

Further, upon completion of the generation of the partition directories 30X, the partitioning of the quantum system resources will not have yet been communicated to and/or applied at the quantum system 501. Rather, these processes are to be performed by the mapping component 216, to be described below.

Regarding the above-described one or more processes of the partitioning component 212, it is recognized that any one or more of these processes can be performed external to the one or more embodiments described herein. For example, in one or more embodiments, partitioning information 244 obtained by the identification component 214 can merely point to and/or comprise one or more already-generated partition directories 30X, partitions 284 and/or partition definitions 285. Thus, in one or more embodiments, the quantum resource partitioning system 202 can omit the partitioning component 212.

The identification component 214, to aid the partitioning component 212, mapping component 216 and/or unmapping component 220, can generally identify, search, receive, transfer, obtain and/or otherwise obtain input data from one or more databases, online resources, entities and/or information caches. The input data can comprise a set of quantum data such as the quantum circuit information 240, which can comprise information defining one or more quantum circuits 242 and/or partition data 244 in its various forms as described above. This input data can be made available to and/or transmitted to the other components of the quantum resource partitioning system 202, such as the partitioning component 212, mapping component 216 and/or unmapping component 220, such as by the identification component 214.

Based on at least one target partition definition 286 for a corresponding partition 284 (comprising one or more quantum system resources), the mapping component 216 can generally direct a controller (e.g., 503 at FIG. 5) of a quantum system (e.g., 501 at FIG. 5) to apply the target partition definition 286 to control electronics 511 of the quantum system for execution of an operation at the quantum processor 506. That is, the mapping component 216 can perform one or more mapping operations to map an entire system configuration (e.g., mapping operation A comprising directing mapping of all current partitions 284) or only a portion of the entire system configuration (e.g., mapping operation B comprising mapping only one or more/less than all target partitions 284).

Likewise, one or more mapping operations by the mapping component 216 can comprise mapping an entire unmapped network configuration (e.g., a mapping operation mapping all unmapped communication links 610) or only a portion of an entire unmapped network configuration (e.g., a mapping operation mapping only one or more/less than all communication links 610).

For any partition 284, associated partition directory 30X and/or corresponding partition definition 285, various mapping operations can be performed by the mapping component 216.

For example, mapping operations can comprise directing, by the mapping component 216 of a controller, of the quantum system 501, regarding the one or more partitions 284. The controller can be a master controller relative to one or more subordinate controllers. The subordinate controllers can be at least partially controlled by the master controller to control the quantum processing unit (QPU) 506. For example, as described above, the orchestrator component 503 can be the controller (e.g., master controller) while the qubit control cards 508 can be the subordinate controllers.

More particularly, the mapping component 216 can direct the controller to apply the target definition 286, such as to its own operations relative to the subordinate controllers. For example, the mapping component 216 can direct the controller to perform one or more write operations to one or more databases of information of a partition definition 285.

In one or more embodiments, the mapping component 216 can direct the controller to send communications to a quantum system resource, such as a target quantum system resource, using a specified target communication link associated with a target partition 284.

In one or more embodiments, a partition definition 285, such as the target partition definition 286, can comprise a target partition ID and/or information regarding the target communication link. As such, in one or more embodiments, the mapping component 216 can direct the controller to execute communications to subordinate controllers based on the target partition definition 286, e.g., using the target communication link and/or including the target partition ID in a communication such that a target subordinate controller will recognize the communication as being directed to the target subordinate controller.

In one or more embodiments, mapping performed by the controller, at direction of the mapping component 216, can be automatically applied to the subordinate controllers, such as relative to direction to observe communications at a particular communication link and/or comprising a particular partition ID. Alternatively, and/or additionally, the mapping component 216 and/or the controller can direct the subordinate controllers, such as relative to the direction to observe communications at a particular communication link and/or comprising a particular partition ID.

In one or more embodiments, where the communication link is not specified in a partition definition 285, the mapping component 216 can identify a target communication link corresponding to a target partition. Based thereon, the mapping component 216 can direct the controller to execute communications to subordinate controllers using the target communication link.

Using the applied and directed mapping of at least the target partition definition 286 (and/or of one or more other partition definitions 285), the execution component 218 can direct employment of a quantum processor (e.g., quantum processor 506 of quantum system 501 of FIG. 5), for execution of a quantum circuit 242 such as by communicating and/or making available a quantum job request 524 to the quantum system 501. That is, the execution component 218 can direct the execution at a quantum processor 506 of the quantum system 501 by directing the quantum system 501 to execute a quantum circuit 242.

Next, prior to discussion of use of the target partition definition 286 (and/or of one or more other partition definitions 285) by the quantum system 501, discussion first turns to a general description of the quantum system 501.

Turning to FIG. 5, one or more embodiments described herein can include one or more devices, systems and/or apparatuses that can provide a process to generate one or more waveforms for a quantum-based operation (e.g., using a quantum device), such as for operating one or more qubits of a quantum device. Accordingly, at FIG. 5, illustrated is a block diagram of an example, non-limiting system 500 that can at least partially facilitate such a process. While referring here to one or more processes, facilitations and/or uses of the non-limiting system 500, description provided herein, both above and below, also can be relevant to one or more other non-limiting systems described herein, such as the non-limiting systems 100 and/or 200.

As illustrated at FIG. 5, the non-limiting system 500 can comprise a quantum system 501 that can be employed with or separate from the classical systems 102/202.

Generally, the quantum system 501 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 520, can be responsive to the quantum job request 524 and associated input data and can be based at least in part on the input data, quantum functions and/or quantum computations.

In one or more embodiments, the quantum system 501 can comprise components, such as a orchestrator component 503, a quantum processor 506, pulse component (e.g., a waveform generator 510) and/or a readout electronics 512 (e.g., readout component).

The quantum processor 506 can comprise one or more, such as plural, qubits 507. Individual qubits 507A, 507B and 507C, for example, can be fixed frequency and/or single junction qubits, such as transmon qubits.

In one or more embodiments, a memory 516 and/or processor 514 can be associated with the orchestrator component 503, where suitable. The processor 514 can be any suitable processor. The processor 514 can generate one or more instructions for controlling the one or more processes of the orchestrator component 503, such as for controlling one or more subordinate controllers (e.g., qubit control cards 508).

The orchestrator component 503 can obtain (e.g., download, receive, search for and/or the like) a quantum job request 524 requesting execution of one or more quantum programs and/or a physical qubit layout. The quantum job request 524 can be provided in any suitable format, such as a text format, binary format and/or another suitable format. In one or more embodiments, the quantum job request 524 can be obtained by a component other than of the quantum system 501, such as a by a component of the classical systems 102/202.

The orchestrator component 503 can determine mapping of one or more quantum logic circuits for executing a quantum program. In one or more embodiments, the orchestrator component 503 and/or quantum processor 506 can direct the waveform generator 510 to generate one or more pulses, tones, waveforms and/or the like to affect one or more qubits 507, such as in response to a quantum job request 524.

In one or more embodiments, more than one orchestrator component 503 can be comprised by the quantum system 501.

The one or more orchestrator components 503 and one or more qubit control cards 508 can be together referred to as control electronics 511. The one or more qubit control cards 508 can be communicatively coupled to the one or more orchestrator components 503.

Qubit control cards 508 can be employed by the quantum processor 506 and disposed within a room temperature environment external to the cryogenic environment 517, as illustrated. In one or more embodiments, one or more aspects of one or more qubit control cards can be disposed within a cryogenic environment 517.

As described above, a qubit control card 508 can be and/or can comprise a qubit drive card (e.g., a waveform generator 510) and/or a qubit acquire card (e.g., readout electronics 512).

As noted above, in one or more embodiments a qubit control card 508 can be provided per qubit 507. In one or more embodiments, a qubit control card 508 can be provided to communicate with more than one qubit 507 per that qubit control card 508. In one or more embodiments, a qubit control card 508 can be and/or can comprise only one of a qubit drive card or a qubit acquire card. In one or more embodiments, a qubit control card 508 can comprise more than one qubit drive card and/or more than one qubit acquire card.

As also noted above, one or more embodiments a qubit drive card can be provided per qubit 507. In one or more embodiments, a qubit drive card can be provided to communicate with more than one qubit 507 per that qubit drive card. In one or more embodiments, a same qubit drive card can be employed for two or more qubits 507.

As further noted above, one or more embodiments a qubit acquire card can be provided per qubit 507. In one or more embodiments, a qubit acquire card can be provided to communicate with more than one qubit 507 per that qubit acquire card. In one or more embodiments, a same qubit acquire card can be employed for two or more qubits 507.

A waveform generator 510 can generally cause at least one qubit 507 of the quantum processor 506 to perform one or more quantum processes, calculations and/or measurements by creating a suitable electro-magnetic signal. For example, the waveform generator 510 can operate one or more qubit effectors, such as qubit oscillators, harmonic oscillators, pulse generators and/or the like to cause one or more pulses to stimulate and/or manipulate the state(s) of the one or more qubits 507 comprised by the quantum system 501. Indeed, a signal can be generated by the waveform generator 510 to affect one or more of the plurality of qubits 507.

In one or more embodiments, the waveform generator 510 can direct application of such electro-magnetic signal by use of the various qubit control cards 508.

The quantum processor 506 can be contained in a cryogenic environment, such as generated by a cryogenic environment 517, such as effected by a dilution refrigerator. Where the plurality of qubits 507 are superconducting qubits, cryogenic temperatures, such as about 4K or lower, can be employed for function of these physical qubits.

The readout electronics 512, or at least a portion thereof, can be contained in a room temperature environment or the cryogenic environment 517, such as for reading a state, frequency and/or other characteristic of qubit, excited, decaying or otherwise. Accordingly, one or more elements of the readout electronics 512 also can be constructed to perform at such cryogenic temperatures.

In one or more embodiments, more than one cryogenic environment, such as more than one dilution refrigerator, can be comprised by the quantum system 501.

It is noted that one or more aspects of the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning now back to FIG. 2 in addition to still referring to FIG. 5, discussion turns to effects at the quantum system 501 of the operations performed by the mapping component 516 and execution component 518.

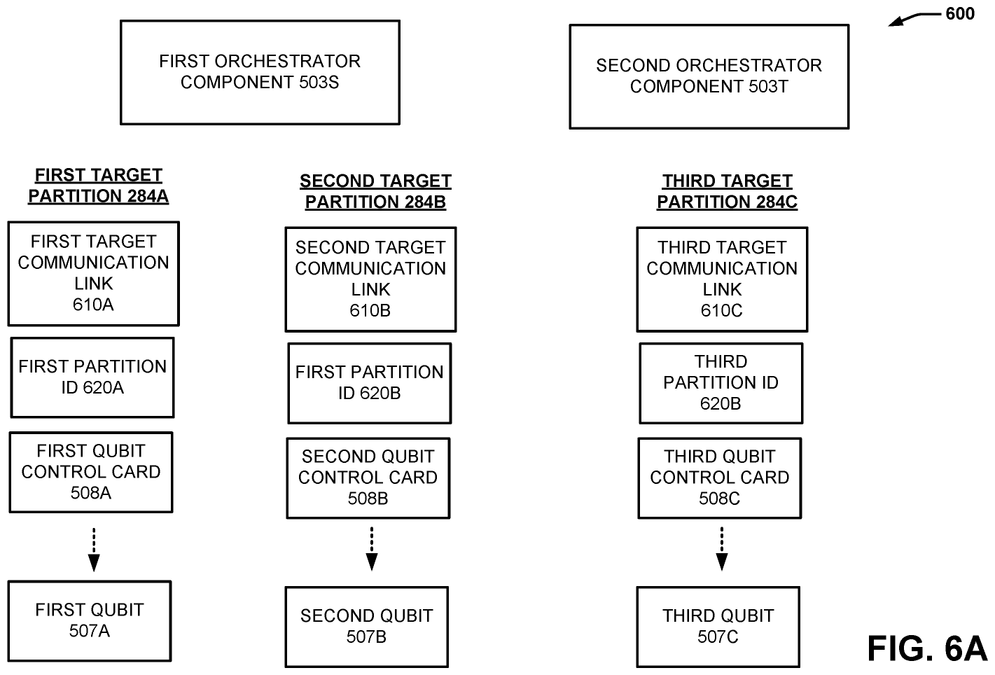

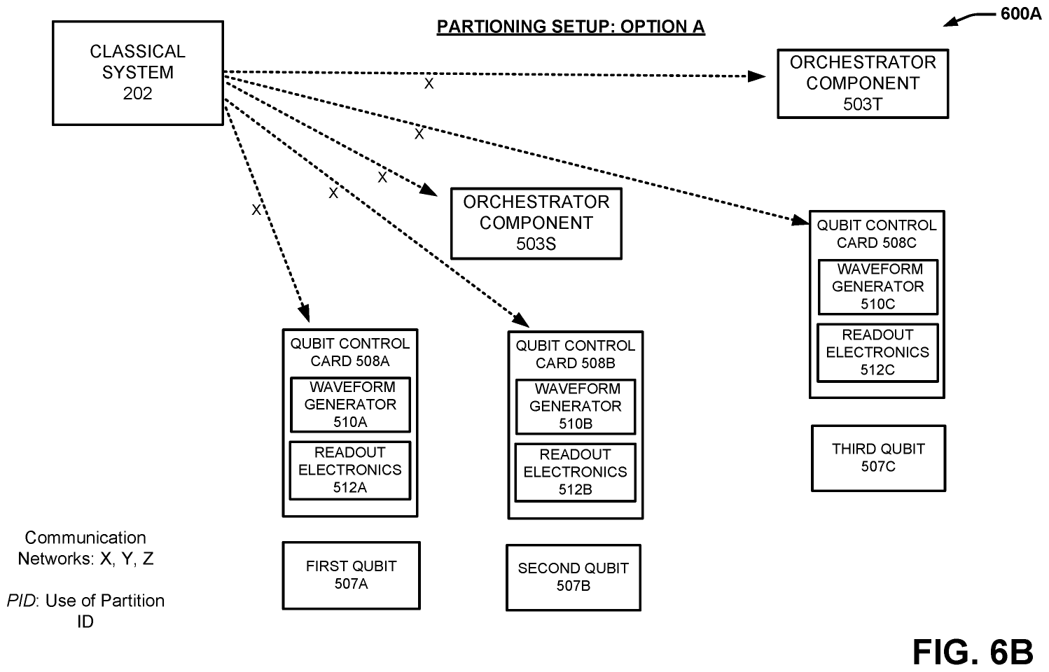

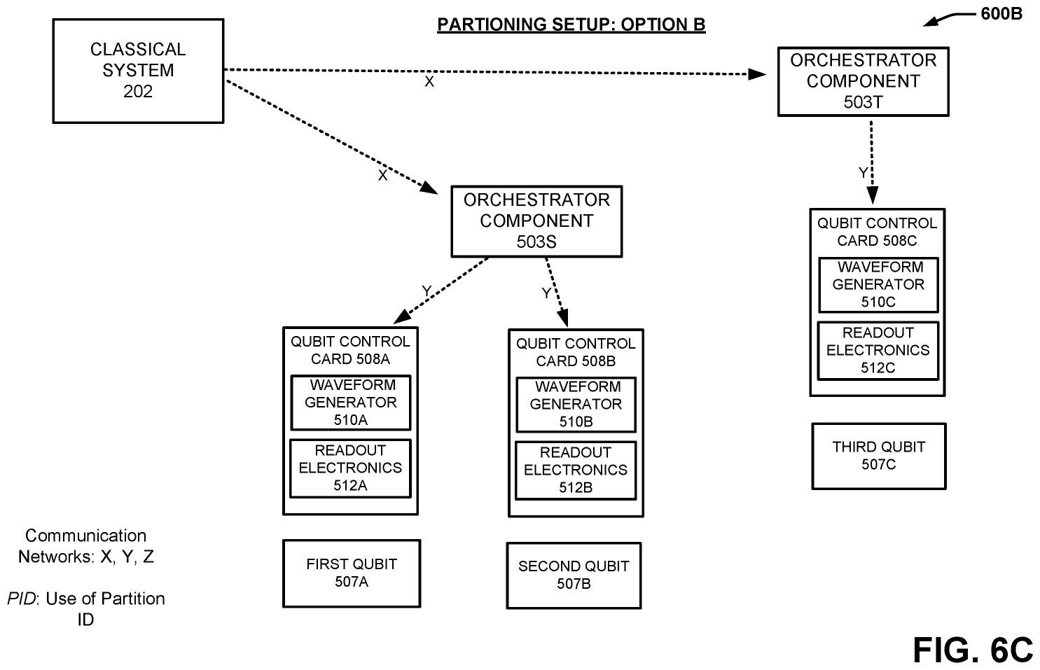

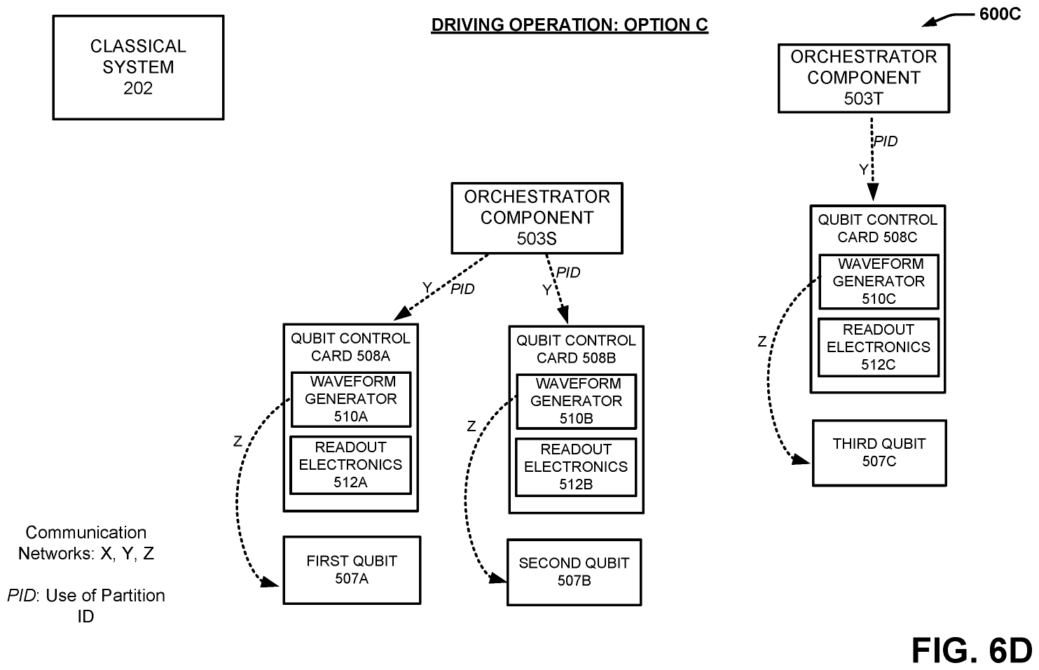

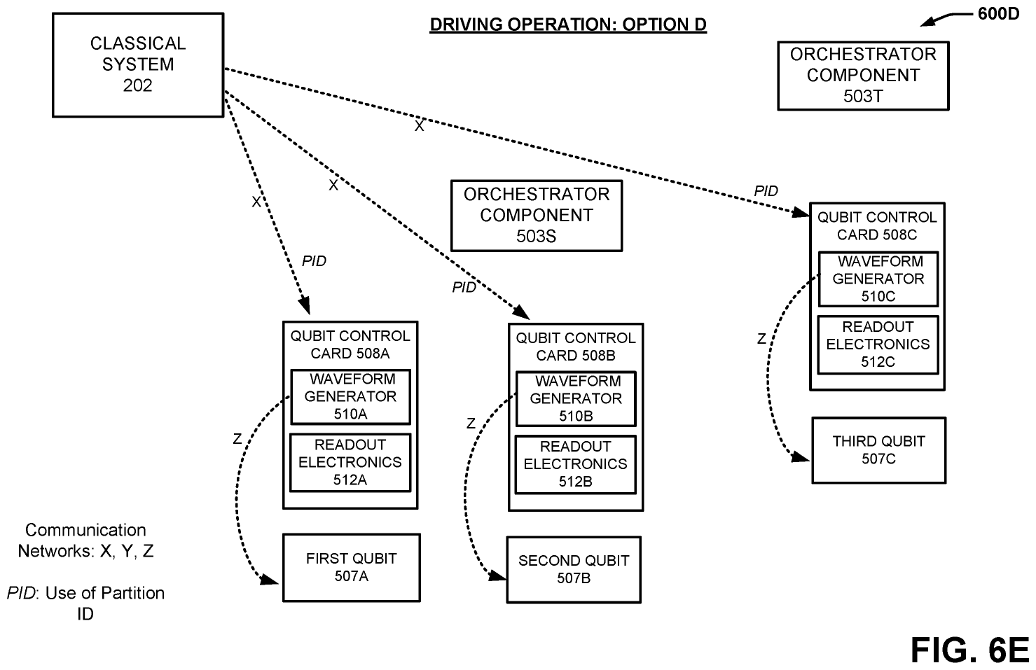

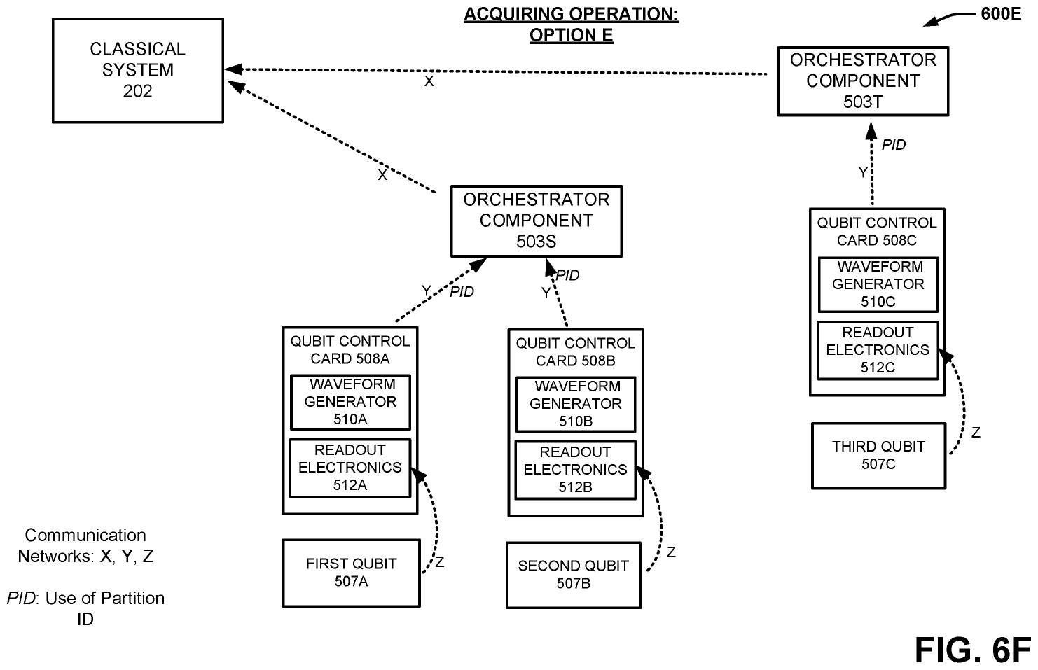

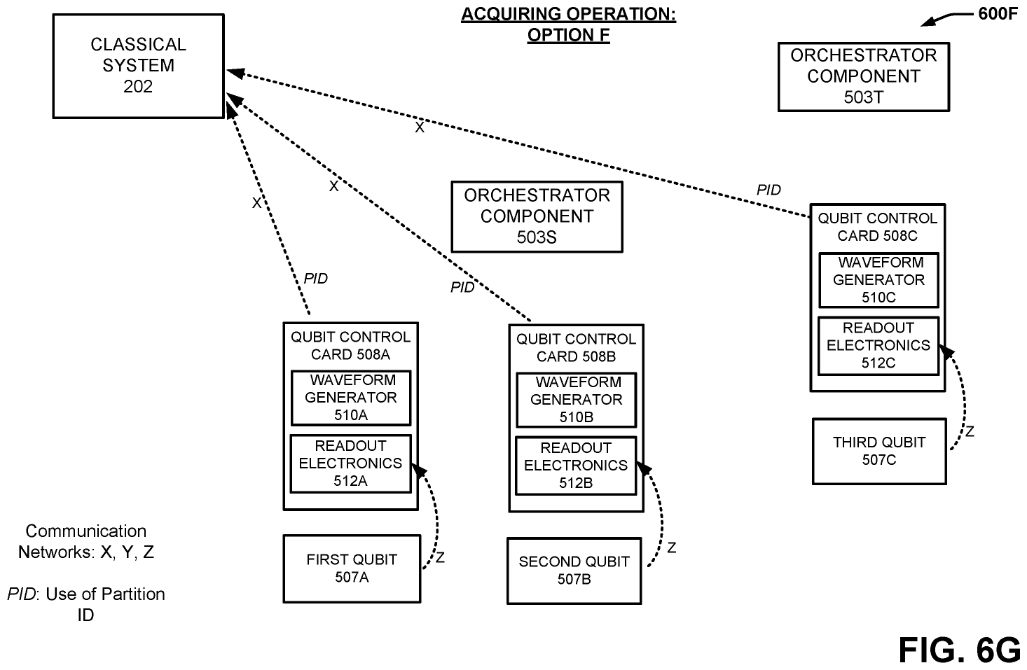

For example, turning additionally to FIG. 6A, provided is a schematic 600 illustrating exemplary effects of the mapping operations performed by the mapping component 516. As shown, a first target partition definition 286A can comprise, define and/or correspond to a first target communication link 610A, first partition ID 620A, first qubit control card 508A and by extension, a first qubit 507A. A second target partition definition 286B can comprise, define and/or correspond to a second target communication link 610b, second partition ID 620B, second qubit control card 508B and by extension, a second qubit 507B. A third target partition definition 286C can comprise, define and/or correspond to a third target communication link 610C, third partition ID 620C, third qubit control card 508C and by extension, a third qubit 507C.

In one or more embodiments, the partition definitions can comprise information regarding communication links 610, such as a communication link 610 per partition 284/target partition definition 286. For example, the first target partition definition 286A can comprise information regarding the first target communication link 610A, the second target partition definition 286B can comprise information regarding the second target communication link 610B, and the third target partition definition 286C can comprise information regarding the third target communication link 610C.

In one or more embodiments, the partition definitions can comprise information regarding partition IDs 620 used by the quantum system resources of a partition 284 to recognize communications to that partition 284 (e.g., to that quantum system resource). For example, the first target partition definition 286A can comprise information regarding the first partition ID 620A, the second target partition definition 286B can comprise information regarding the second partition ID 620B, and the third target partition definition 286C can comprise information regarding the third partition ID 620C.

As also illustrated at FIG. 6A, one or more target partitions 284 can be controlled by an orchestrator component 503, with different orchestrator components controlling different target partitions 284. As illustrated, the first orchestrator component 503S controls the first target partition 284A and the second target partition 284B, while the second orchestrator component 503T controls the third target partition 284C. This mapping between orchestrator components 503 and qubit control cards 508 can be reconfigured based on one or more mapping operations performed by the mapping component 216.

That is, in one or more embodiments, execution of the mapping based on the direction provided by the mapping component 216, by the controller 503 and/or qubit control card 508, can comprise one or more mapping write operations to one or more databases associated with the controller.

In one or more embodiments, in response to the direction to the controller 503, the controller 503 can direct execution of a quantum circuit 242 using a target qubit (e.g., qubit 507A), by sending a first communication using a communication link (e.g., target communication link 610) associated with the partition 284 comprising (e.g., specifying) the target qubit. This can comprise sending, to the quantum system resource (e.g., to a target qubit controller 508), by the controller 503, a communication directing execution at the target qubit 507 of a waveform. The communication can be sent using the target communication link 610 associated with the target partition 284. In one or more embodiments, the communication can comprise a target partition ID 620 associated with the target partition and recognized by the quantum system resource as corresponding to the quantum system resource.

In response thereto, the qubit control card 508 (such as being and/or comprising a drive card) can perform a driving action to generate a waveform at the target qubit 507, using the target communication link 610, thereby altering a state of the target qubit 507. In response to effect of the waveform at the target qubit 507, the qubit control card 508 or another qubit card associated with the target qubit 507 (such as being and/or comprising an acquire card) can perform an acquiring action to read and/or detect information defining a changed state, frequency and/or rotation of the target qubit 507, thereby obtaining target readout information for the target qubit 507. As a result thereof, the controller 503 can obtain and/or receive the target readout information for the target qubit 507, using the target communication link 610, from the target qubit control card 508.

Turning now to FIGS. 6B to 6G, varying different partitioning setup options, driving operation options and acquiring operation options are illustrated that may be different from the previous two paragraphs in one or more ways.

For example, each of FIGS. 6B to 6G illustrates a classical system 202 (e.g., the quantum resource partitions system 202) as communicatively coupled to one or more orchestrator components 503 (as illustrated a first orchestrator component 503S and a second orchestrator component 503T) and one or more subordinate controllers, such as qubit control cards 508 (as illustrated a first qubit control card 508A, second qubit control card 508B and third qubit control card 508C).

As illustrated first at a partitioning setup: option A at FIG. 6B, a partitioning/mapping operation for the control electronics 511 can comprise sending one or more mapping communications to both the orchestrator components 503 and the qubit control cards 508 rom the classical system 202. These communications can be sent over a communication network X.

The communication network X from the classical system 202 to the control electronics 511 can be high speed ethernet and/or comparable alternative. This setup network can be used to configure the orchestrator components 503 and/or qubit control cards 508 to be part of a partition 284. This setup is also can be used to adjust the communication network X to forward packets for the partitions or not, such as setting up one or more rules and/or instructions as to whether a packet should be forwarded or not on the communication network Y between the one or more orchestrator components 503 and the qubit control electronics 511. This setup network also can be used to transfer code/data to the control electronics 511 as part of a quantum job-loading process.

After individual pieces of a quantum job have been loaded, the control electronics 511 can be started to drive an experiment. While the experiment is running, the communication network X can be used to obtain detailed measurement information.

As illustrated next at a partitioning setup: option B at FIG. 6C, a partitioning/mapping operation for the control electronics 511 can comprise sending one or more mapping communications to the orchestrator components 503 from the classical system 202. These communications can be sent over a communication network X. One or more mapping communications can then be broadcast to the respective qubit control cards 508 by the orchestrator components 503 (e.g., to the qubit control cards 508 to which the orchestrator components 503 are mapped in view of the first mapping communications. These secondary broadcast communications can be sent of a communication network Y.

One or more aspects of a communication network Y can comprise the communication links 610. This communication network Y can be a highspeed low latency network used during the experiment when the qubit control cards 508 are controlling the qubits 507. Mapping, driving and/or acquiring communications sent over this communication network Y can employ respective partition IDs 620 in the packets to ensure the partition isolation for the controllers of the control electronics 511 that are dedicated to the respective individual partitions 284. This communication network Y can be employed to exchange information between the orchestrator components 503 and the qubit control cards 598 in a fast manner while an experiment is running.

As illustrated next at a driving operation: option C at FIG. 6D, a driving operation for ultimately affecting one or more qubits 507 can comprise sending one or more driving communications from an orchestrator component 503 over a mapped communication link 610 of the communication network Y, to a target qubit control card 508, with the one or more driving communications employing a target partition ID 620 that is associated with the partition 284 of which the target qubit control card 508 is assigned. A waveform generator 510 can send a waveform signal, pulse, etc. over a communication network Z to a respective target qubit 507.

The communication network Z can be any suitable network providing an analog transmission path between the qubit control electronics 511 and the qubits 507.

As illustrated next at a driving operation: option D at FIG. 6E, a driving operation for ultimately affecting one or more qubits 507 can comprise sending one or more driving communications from the classical system 202 over the communication network X, bypassing the respective and mapped orchestrator component 503, to a target qubit control card 508, with the one or more driving communications employing a target partition ID 620 that is associated with the partition 284 of which the target qubit control card 508 is assigned. A waveform generator 510 can send a waveform signal, pulse, etc. over a communication network Z to a respective target qubit 507.

As illustrated next at an acquiring operation: option E at FIG. 6F, an acquiring operation for ultimately transferring one or more readout measurements 520 to the classical system 202 can comprise a respective readout electronics 512 acquiring information (e.g., data, metadata, readings and/or measurements) from a target qubit 507 corresponding to the target qubit control card 508 comprising, and/or associated with, the respective readout electronics 512, over a communication network Z. An orchestrator component 503 can obtain an acquiring communication from the target qubit control card 508, over a communication network Y, and employing a respective partition ID 620. Thereafter, a corresponding acquiring communication can be sent by the orchestrator component 503 and/or obtained by the classical system 202 using the communication network X, from which the classical system 202 can determine a measurement corresponding to the target qubit 507.

As illustrated next at an acquiring operation: option F at FIG. 6G, an acquiring operation for ultimately transferring one or more readout measurements 520 to the classical system 202 can comprise a respective readout electronics 512 acquiring information (e.g., data, metadata, readings and/or measurements) from a target qubit 507 corresponding to the target qubit control card 508 comprising, and/or associated with, the respective readout electronics 512, over a communication network Z. The classical system 202 (e.g., a component thereof) can obtain an acquiring communication from the target qubit control card 508, over the communication network X, and employing a respective partition ID 620, such as bypassing a respective orchestrator component 503 of the partition 284 comprising the target qubit control card 508. Thereafter, the classical system 202 can determine a measurement corresponding to the target qubit 507.

Discussion next turns to the unmapping component 220 which generally can perform one or more unmapping operations relative to the partitions 284 mapped by the mapping component 216 and corresponding to at least a target quantum system resource of the quantum system 501. For example, the unmapping component 220 can direct the controller to clear the target partition definition and/or any associated mapping applied to the quantum system 501 by the controller 503 as a result of a mapping operation performed by the mapping component 216. Further, the unmapping component 220 can direct the controller 503 to stop use of the target communication link altogether or as corresponding to the target partition, in view of unmapping of a respective partition.

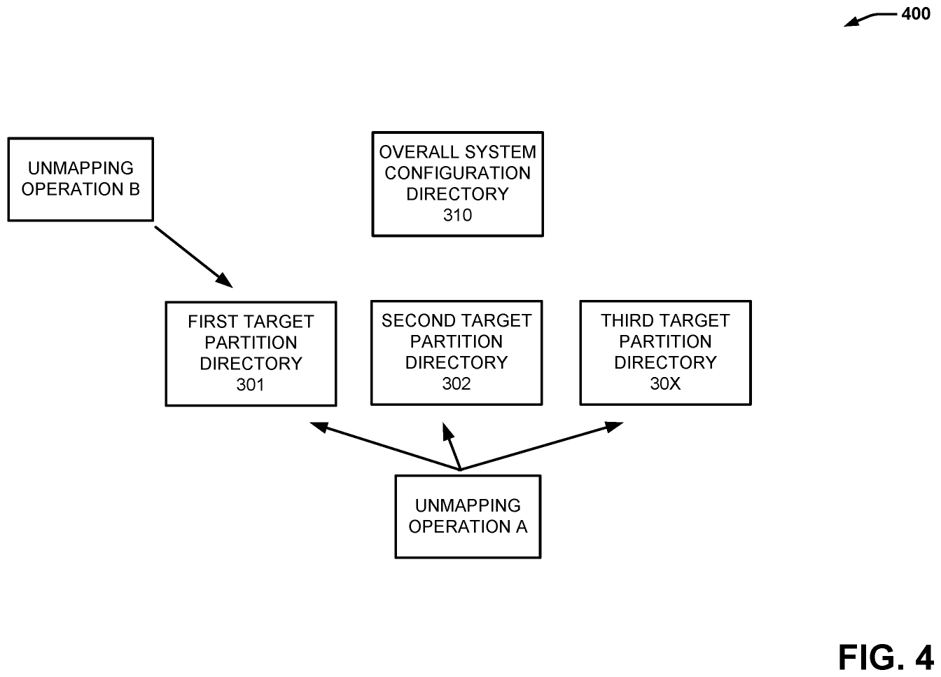

For example, as illustrated at schematic 400 of FIG. 4, the unmapping component 220 can perform one or more unmapping operations to unmap an entire system configuration (e.g., unmapping operation A comprising directing unmapping of all current partitions 284) or only a portion of the entire system configuration (e.g., unmapping operation B comprising unmapping only one or more/less than all target partitions 284).

Likewise, one or more unmapping operations by the unmapping component 220 can comprise unmapping an entire mapped network configuration (e.g., an unmapping operation unmapping all mapped communication links 610) or only a portion of an entire mapped network configuration (e.g., an unmapping operation unmapping only one or more/less than all communication links 610).

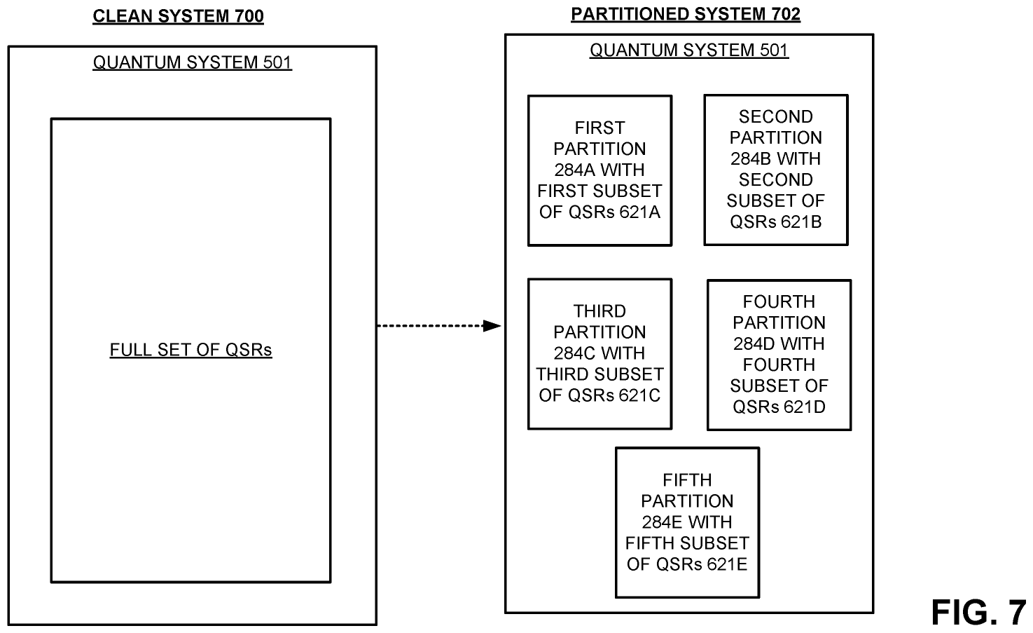

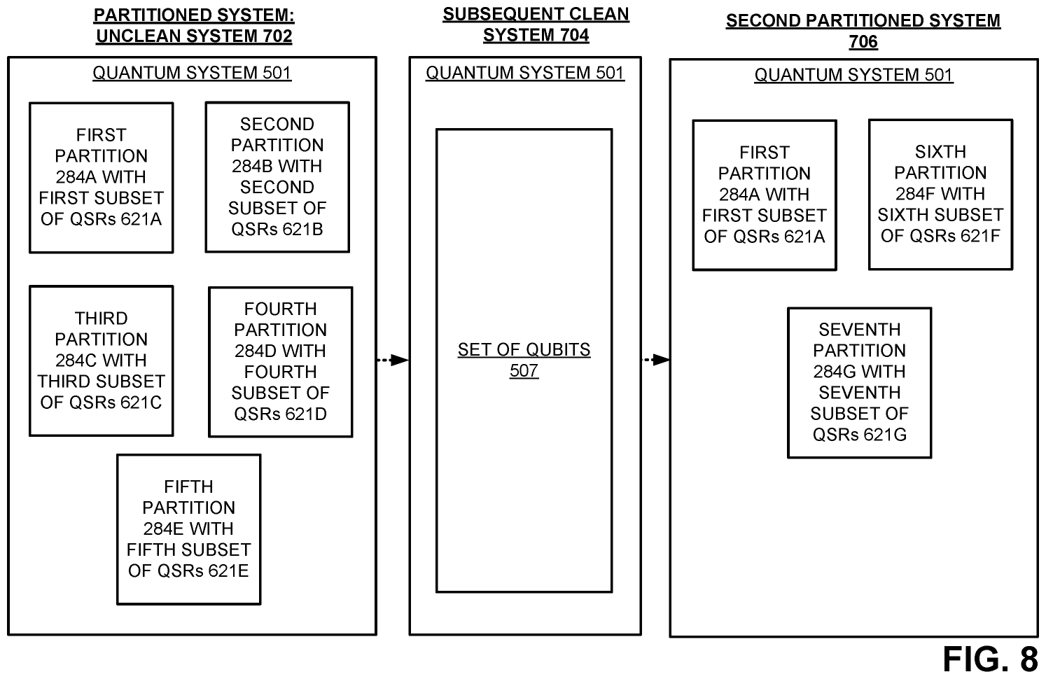

Turning now to FIGS. 7 and 8, illustrating still additional aspects related to the above components, elements, aspects and/or processes described relative to FIGS. 1 to 6, illustrated are various schematics 700, 702, 704 and 706 of various partitioning states of the quantum system 501.

As illustrated at FIG. 7, a clean system 700 can comprise omission of any partition definitions 285 applied thereto by the mapping component 216. In response to performance of one or more mapping operations by the mapping component, a partitioned system 702 (also an unclean system) can have one or more partitions 284 applied thereto. As illustrated the partitioned system 702 has five partitions applied thereto (284A, 284B, 284C, 284D or 284E) each having associated therewith a different subset of quantum system resources (QSRs) 621A, 621B, 6t21C, 621D or 621E.

As illustrated at FIG. 8, the partitioned (e.g., configured) system 702 can be subsequently cleaned of any partition definitions 285 and/or partition mappings of the partitions 284, such as in response to one or more unmapping operations performed by the unmapping component 220. Because the quantum resource partitioning performed by the quantum resource partitioning system 202 can be reconfigurable, it is appreciated that a second configured or partitions system 706 can comprise at least one different partition than the partitioned system 702. As such, the illustrated partitioned system 706 comprises the first partition 284A and also a new partition 284F and a new partition 284G.

Differently, it is appreciated that the second partitioned system 706 can result from the first partitioned system 702 without the subsequent clean system 704 being applied by the unmapping component 220.

Indeed, using the various processes discussed above that can be performed by the various components of the quantum resource partitioning system, dynamic reconfiguration can be applied to the quantum system resources of the quantum system 501. For example, unmapping and/or mapping operations can be performed by the quantum resource partitioning system 202 relative to at least one or more quantum system resources while one or more other quantum system resources are being employed by the quantum system 501, such as to execute a quantum job (e.g., execute a quantum circuit 242). Put another way, unmapping and/or mapping operations can be performed by the quantum resource partitioning system 202 relative to at least one partition 284 while one or more other partitions 284 are being employed by the quantum system 501.

A limit on this scalability and reconfigurability can be that a quantum system resource or a partition cannot be reconfigured (e.g., mapped and/or unmapped) when the quantum system resource, or a quantum system resource of the respective partition, is being employed by the quantum system 501 (e.g., to execute a quantum job, during a calibration thereof, etc.).

For example, looking to the second partitioned system 706 of FIG. 8, while one or more quantum system resources of the first partition 284A are being used, the second, third, fourth and fifth partitions (284B-284E) can be unmapped. However, the first partition 284A cannot be unmapped while a quantum system resource thereof is being employed by the quantum system 501.

Further, there is no particular order of mapping and/or unmapping that is required to be followed by the quantum resource partitioning system, other than the limitation discussed above. That is, unmapping can be performed before mapping and/or vice versa.

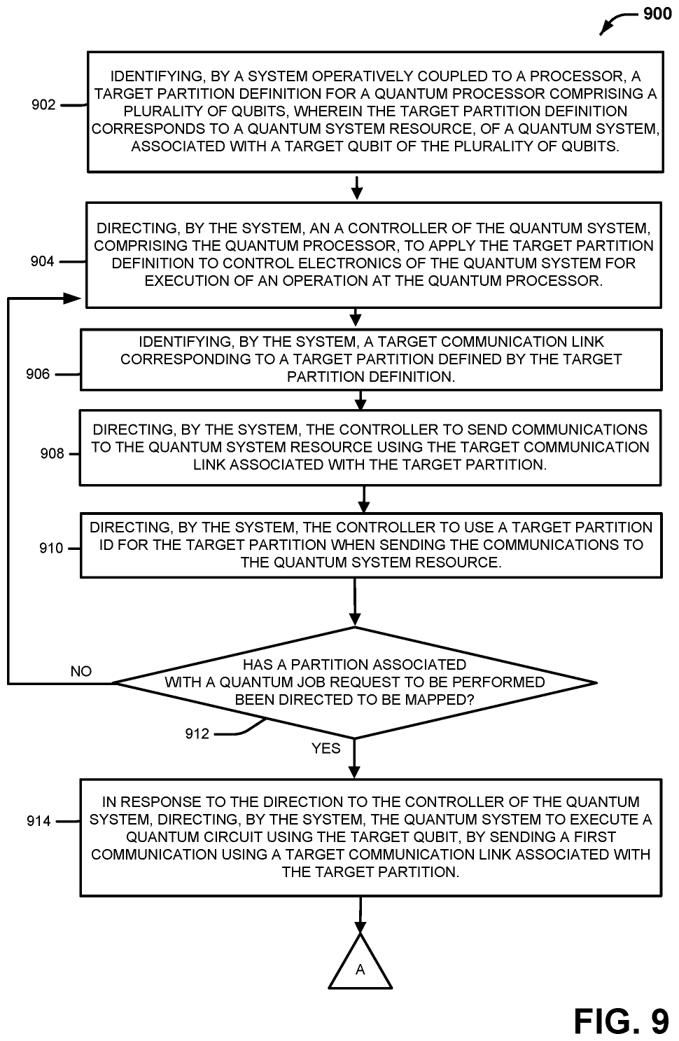

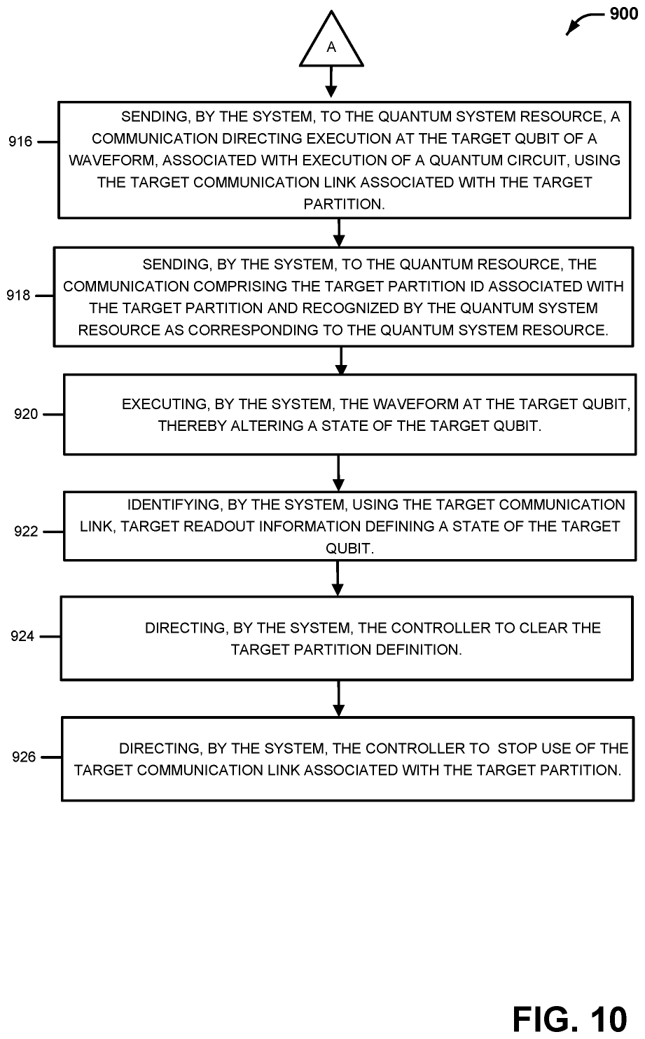

As a summary, referring next to FIGS. 9 and 10, illustrated is a flow diagram of an example, non-limiting method 900 that can provide a process to map and unmap quantum system resources of a quantum system (e.g., quantum system 501), in accordance with one or more embodiments described herein, such as the non-limiting system 200 of FIG. 2. While the non-limiting method 900 is described relative to the non-limiting system 200 of FIG. 2, the non-limiting method 900 can be applicable also to other systems described herein, such as the non-limiting system 100 of FIG. 1. Repetitive description of like elements and/or processes employed in respective embodiments is omitted for sake of brevity.

At 902, the non-limiting method 900 can comprise identifying, by a system operatively coupled to a processor (e.g., identification component 214), identifying, a target partition definition (e.g., target partition definition 286) for a quantum processor (e.g., quantum processor 506) comprising a plurality of qubits (e.g., qubits 507), wherein the target partition definition corresponds to a quantum system resource (e.g., target qubit control card 508A), of a quantum system (e.g., quantum system 501), associated with a target qubit (e.g., target qubit 507A) of the plurality of qubits.

In one or more embodiments, the target partition definition can comprise information defining a target partition ID for the target partition and defining a target communication link corresponding to the target partition.

At 904, the non-limiting method 900 can comprise, directing, by the system (e.g., mapping component 216), a controller (e.g., controller/orchestrator component 503) of the quantum system, comprising the quantum processor, to apply the target partition definition to control electronics (e.g., control electronics 511) of the quantum system for execution of an operation (e.g., execution of a quantum circuit 242) at the quantum processor.

At 906, the non-limiting method 900 can comprise identifying, by the system (e.g., mapping component 216), a target communication link (e.g., target communication link 611) corresponding to a target partition (e.g., target partition 284) defined by the target partition definition.

At 908, the non-limiting method 900 can comprise directing, by the system (e.g., mapping component 216), the controller to send communications to the quantum system resource using the target communication link associated with the target partition.

At 910, the non-limiting method 900 can comprise directing, by the system (e.g., mapping component 216), the controller to use a target partition ID (e.g., target partition ID 620) for the target partition when sending the communications to the quantum system resource.

At 912, the non-limiting method 900 can comprise determining, by the system (e.g., execution component 218) whether a partition associated with a quantum job request (e.g., quantum job request 524) has been directed to be mapped by the controller.

If yes, the non-limiting method can proceed to step 914. If no, the non-limiting method can proceed back to step 904 for execution of one or more operations by the mapping component 216.

At 914, the non-limiting method 900 can comprise, in response to the direction to the controller of the quantum system, directing, by the system (e.g., execution component 218), the quantum system to execute a quantum circuit (e.g., quantum circuit 242) using the target qubit, by sending a first communication using a target communication link associated with the target partition.

At 916, the non-limiting method 900 can comprise sending, by the system (e.g., controller/orchestrator component 503), to the quantum system resource, a communication directing execution at the target qubit of a waveform, associated with execution of a quantum circuit, using the target communication link associated with the target partition.

At 918, the non-limiting method can comprise, sending, by the system (e.g., controller/orchestrator component 503), to the quantum system resource, the communication comprising the target partition ID associated with the target partition and recognized by the quantum system resource as corresponding to the quantum system resource.

At 920, the non-limiting method 900 can comprise executing, by the system (e.g., by the quantum system resource, such as qubit control card 508), the waveform at the target qubit, thereby altering a state of the target qubit.

At 922, the non-limiting method 900 can comprise identifying, by the system (e.g., controller/orchestrator component 503), using the target communication link, target readout information defining a state of the target qubit.

At 924, the non-limiting method 900 can comprise directing, by the system (e.g., unmapping component 220), the controller to clear the target partition definition.

At 926, the non-limiting method 900 can comprise directing, by the system (e.g., unmapping component 220), the controller to stop use of the target communication link associated with the target partition.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide a system, computer-implemented method and/or computer program product to provide for control of a quantum system 501 through use of partitioning of resources of the quantum system 501. A system 100, 200 comprises a memory 104, 204 that stores and a processor 106, 206 that executes computer executable components stored in the memory 104, 204, wherein the computer executable components comprise an identification component 114, 214 that identifies a target partition definition 186, 286 for a quantum processor 506 comprising a plurality of qubits 507, and a mapping component 216 that directs a controller 503 of a quantum system 501, comprising the quantum processor 506, to apply the target partition definition 186, 286 to control electronics 511 of the quantum system 501 for execution of an operation at the quantum processor 506, wherein the target partition definition 186, 286 corresponds to a quantum system resource (e.g., target qubit control card 508) associated with a target qubit 507 of the plurality of qubits 507.

That is, the one or more embodiments described herein can provide for automatically mapping and unmapping quantum system resources, such as qubits, qubit cards (e.g., qubit acquire cards, qubit drive cards, qubit control cards), etc. based on partition definitions identified and/or generated by the one or more embodiments, wherein the partition definitions can be based on quantum system resource information at a directory communicatively coupled to the one or more embodiments.

Put another way, rather than partitioning data within a central controller, as in existing frameworks, the one or more embodiments described herein can direct the partitioning of various resources (e.g., quantum system resources), thereby rapidly adjusting a definition of one physical system (e.g., quantum system) into two or more independent, logical systems (e.g., quantum sub-systems).

A benefit of the system, computer-implemented method and/or computer program product can be that the mapping and unmapping operations performed are not tied to any particular job. Rather, dynamic reconfiguration of partitioning of a set of quantum system resources of a quantum system can be repeatedly performed for part or all of the set of quantum system resources. In this way, the partitioning can be reconfigurable to construct different sized logical systems from the quantum system for use with varying quantum job requests.

Yet another benefit of the system, computer-implemented method and/or computer program product can be a significant reduction in bring up time (e.g., comprising initialization and/or calibration) of a quantum system comprising a plurality of qubits. For example, relative to a quantum system comprising 400 or more qubits, a bring up time can be reduced from months to less than two weeks.

In connection with this benefit, the one or more embodiments described herein can allow for less overall downtime of qubits of the quantum system. That is, by partitioning off logical subsystems of a quantum system, some qubits can be calibrated (e.g., of one partition) while other qubits can be employed to execute a quantum job (e.g., of another partition). Further, this partitioning can be reconfigured and changed for new calibrations and/or quantum job requests.

Still another benefit of the system, computer-implemented method and/or computer program product can be use of partitioning to exclude one or more quantum system resources (e.g., provide partition of quantum system resources to not be used for any particular quantum job) to allow for segregation of broken hardware (e.g., hardware failure), hardware subject to a troubleshooting operation, and/or hardware that is failing to calibrate properly, among other suitable purposes. This can be a desirable alternative to taking an entire quantum system offline.

Another benefit of the system, computer-implemented method and/or computer program product described herein can generally be an improvement in the functioning of a quantum computer, such as related to initialization, calibration, and or communication between different hierarchal levels of controllers of the quantum system. This improvement improves the function of a quantum computer relative to existing quantum systems. Indeed, for a non-limiting system comprising both a classical system as described herein and a quantum system as described herein (e.g., comprising a quantum computer), such non-limiting system can be self-improving through partitioning of resources for a quantum job, making initialization, calibration and/or communication shorter and/or more efficient for that quantum job.

Indeed, in view of the one or more embodiments described herein, a practical application of the one or more systems, computer-implemented methods and/or computer program products described herein can be increased use of a quantum system by reducing bring up time and by allowing the quantum system to be employed as various logical subsystems for various different types of quantum jobs.

In connection therewith, the one or more embodiments described herein can provide useful and practical applications of computers, thus providing enhanced (e.g., improved and/or optimized) quantum system bring up as compared to existing frameworks. Overall, such computerized tools can constitute a concrete and tangible technical improvement in the fields of quantum processing.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to quantum system resource partitioning, as compared to existing systems and/or techniques unable to provide such quantum system resource partitioning. Systems, computer-implemented methods and/or computer program products providing performance of these processes are of great utility in the fields of quantum circuit operation and/or quantum computing more generally and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically perform quantum system resource partitioning of digital data and/or digital resources as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise an identification component that identifies a target partition definition for a quantum processor comprising a plurality of qubits; and a mapping component that directs a controller of a quantum system, comprising the quantum processor, to apply the target partition definition to control electronics of the quantum system for execution of an operation at the quantum processor, wherein the target partition definition corresponds to a quantum system source, of the quantum system, associated with a target qubit of the plurality of qubits.

The system of the preceding paragraph, wherein the mapping component directs the controller to send communications to the quantum system resource using a target communication link associated with the target partition definition.

The system of any preceding paragraph, wherein the mapping component further directs the controller to use a target partition ID for a target partition defined by the target partition definition when sending the communications to the quantum system resource.

The system of any preceding paragraph, wherein the mapping component identifies the target communication link corresponding to the target partition definition.

The system of any preceding paragraph, further comprising an execution component that, in response to the direction to the controller of the quantum system, directs the quantum system to execute a quantum circuit using the target qubit, by sending a first communication using a target communication link associated with the target partition definition.

The system of any preceding paragraph, further comprising an unmapping component that directs the controller to clear the target partition definition.

The system of any preceding paragraph, wherein the target partition definition comprises information defining a target partition ID for a target partition and a target communication link corresponding to the target partition.

A computer-implemented method, comprises identifying, by a system operatively coupled to a processor, a target partition definition for a quantum processor comprising a plurality of qubits; and directing, by the system, a controller of a quantum system, comprising the quantum processor, to apply the target partition definition to control electronics of the quantum system for execution of an operation at the quantum processor, wherein the target partition definition corresponds to a quantum system resource, of the quantum system, associated with a target qubit of the plurality of qubits.

The computer-implemented method of the preceding paragraph, further comprising directing, by the system, the controller to send communications to the quantum system resource using a target communication link associated with the target partition definition.

The computer-implemented method of any preceding paragraph, further comprising directing, by the system, the controller to use a target partition ID for a target partition defined by the target partition definition when sending the communications to the quantum system resource.

The computer-implemented method of any preceding paragraph, further comprising identifying, by the system, the target communication link corresponding to the target partition definition.

The computer-implemented method of any preceding paragraph, further comprising, in response to the direction to the controller of the quantum system, directing, by the system, the quantum system to execute a quantum circuit using the target qubit, by sending a first communication using a target communication link associated with the target partition definition.

The computer-implemented method of any preceding paragraph, further comprising, directing, by the system, the controller to clear the target partition definition and to stop use of a target communication link associated with the target partition definition.

The computer-implemented method of any preceding paragraph, wherein the target partition definition comprises information defining a target partition ID for a target partition and the target communication link corresponding to the target partition.

The computer-implemented method of any preceding paragraph, further comprising sending to the quantum system resource, by the controller, a communication directing execution at the target qubit of a waveform, associated with execution of a quantum circuit, using a target communication link associated with the target partition definition.

The computer-implemented method of any preceding paragraph, wherein the communication comprises a target partition ID associated with the target partition definition and recognized by the quantum system resource as corresponding to the quantum system resource.

The computer-implemented method of any preceding paragraph, further comprising executing, by the quantum system resource, the waveform at the target qubit, thereby altering a state of the target qubit.

The computer-implemented method of any preceding paragraph, further comprising identifying, by the controller, using the target communication link, target readout information defining a state of the target qubit.

A computer program product facilitating a process to manage a set of partitions corresponding to a set of qubits of a quantum processor of a quantum system, the computer program product comprising a computer readable storage medium having program instructions embodied therewith, the program instructions executable by a processor to cause the processor to identify, by the processor, a target partition definition for the quantum processor comprising the set of qubits; and direct, by the processor, a controller of the quantum system, comprising the quantum processor, to apply the target partition definition to control electronics of the quantum system for execution of an operation at the quantum processor, wherein the target partition definition corresponds to a quantum system resource, of the quantum system, associated with a target qubit of the set of qubits.

The computer program product of the preceding paragraph, wherein the program instructions are further executable by the processor to cause the processor to direct, by the processor, based on the target partition definition, the controller to send a communication to the quantum system resource using a target communication link associated with the target partition definition and to send the communication using a target partition ID associated with the target partition definition.

### Computing Environment Description

Turning next to FIG. 11, a detailed description is provided of additional context for the one or more embodiments described herein at FIGS. 1-10.

FIG. 11 and the following discussion are intended to provide a brief, general description of a suitable computing environment 1100 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the quantum system partitioning code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine that collects and stores helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an identification component that identifies a target partition definition for a quantum processor comprising a plurality of qubits; and
a mapping component that directs a controller of a quantum system, comprising the quantum processor, to apply the target partition definition to control electronics of the quantum system for execution of an operation at the quantum processor,
wherein the target partition definition corresponds to a quantum system resource, of the quantum system, associated with a target qubit of the plurality of qubits.

2. The system of claim 1, wherein the mapping component directs the controller to send communications to the quantum system resource using a target communication link associated with the target partition.

3. The system of claim 2, wherein the mapping component further directs the controller to use a target partition ID for the target partition when sending the communications to the quantum system resource.

4. The system of claim 2, wherein the mapping component identifies the target communication link corresponding to the target partition.

5. The system of claim 1, further comprising:
an execution component that, in response to the direction to the controller of the quantum system, directs the quantum system to execute a quantum circuit using the target qubit, by sending a first communication using a target communication link associated with the target partition.

6. The system of claim 1, further comprising:
an unmapping component that directs the controller to clear the target partition definition.

7. The system of claim 1, wherein the target partition definition comprises information defining a target partition ID for the target partition and defining a target communication link corresponding to the target partition.

8. A computer-implemented method, comprising:
identifying, by a system operatively coupled to a processor, a target partition definition for a quantum processor comprising a plurality of qubits; and
directing, by the system, a controller of a quantum system, comprising the quantum processor, to apply the target partition definition to control electronics of the quantum system for execution of an operation at the quantum processor,
wherein the target partition definition corresponds to a quantum system resource, of the quantum system, associated with a target qubit of the plurality of qubits.

9. The computer-implemented method of claim 8, further comprising:
directing, by the system, the controller to send communications to the quantum system resource using a target communication link associated with the target partition.

10. The computer-implemented method of claim 9, further comprising:
directing, by the system, the controller to use a target partition ID for the target partition when sending the communications to the quantum system resource.

11. The computer-implemented method of claim 9, further comprising:
identifying, by the system, the target communication link corresponding to the target partition.

12. The computer-implemented method of claim 8, further comprising:
in response to the direction to the controller of the quantum system, directing, by the system, the quantum system to execute a quantum circuit using the target qubit, by sending a first communication using a target communication link associated with the target partition.

13. The computer-implemented method of claim 8, further comprising:
directing, by the system, the controller to clear the target partition definition and to stop use of a target communication link associated with the target partition.

14. The computer-implemented method of claim 8, wherein the target partition definition comprises information defining a target partition ID for the target partition and the target communication link corresponding to the target partition.

15. The computer-implemented method of claim 8, further comprising:
sending to the quantum system resource, by the controller, a communication directing execution at the target qubit of a waveform, associated with execution of a quantum circuit, using a target communication link associated with the target partition.

16. The computer-implemented method of claim 15, wherein the communication comprises a target partition ID associated with the target partition and recognized by the quantum system resource as corresponding to the quantum system resource.

17. The computer-implemented method of claim 15, further comprising:
executing, by the quantum system resource, the waveform at the target qubit, thereby altering a state of the target qubit.

18. The computer-implemented method of claim 8, further comprising:
identifying, by the controller, using the target communication link, target readout information defining a state of the target qubit.

19. A computer program product facilitating a process to manage a set of partitions corresponding to a set of qubits of a quantum processor of a quantum system, the computer program product comprising a computer readable storage medium having program instructions embodied therewith, the program instructions executable by a processor to cause the processor to:
identify, by the processor, a target partition definition for the quantum processor comprising the set of qubits; and
direct, by the processor, a controller of the quantum system, comprising the quantum processor, to apply the target partition definition to control electronics at the quantum system for execution of an operation at the quantum processor,
wherein the target partition definition corresponds to a quantum system resource, of the quantum system, associated with a target qubit of the set of qubits.

20. The computer program product of claim 15, wherein the program instructions are further executable by the processor to cause the processor to:
direct, by the processor, based on the target partition definition, the controller to send a communication to the quantum system resource using a target communication link associated with the target partition and to send the communication using a target partition ID associated with the target partition.
